(19) United States
(12) Patent Application Publication
(10) Pub. No.: US 2020/0249046 A1
(43) Pub. Date: Aug. 6, 2020

(54) SYSTEMS AND METHODS FOR PREDICTING TRAVEL DESTINATION OF AN AUTOMOBILE BASED ON ATTIRE WORN BY INDIVIDUAL

(71) Applicant: Ford Global Technologies, LLC, Dearborn, MI (US)

(72) Inventor: Scott Mayberry, Allen Park, MI (US)

(73) Assignee: Ford Global Technologies, LLC, Dearborn, MI (US)

(21) Appl. No.: 16/267,088

(22) Filed: Feb. 4, 2019

(51) Int. Cl. G01C 21/36; G06K 9/00; G06N 5/04; G08G 1/0968

(52) U.S. Cl. CPC G01C 21/3617; G08G 1/096888; G06N 5/046; G06K 9/00845

(57) ABSTRACT

Exemplary embodiments described in this disclosure are generally directed to systems and methods for predicting a travel destination of an automobile based at least in part on identifying a category of an attire worn by an individual who is an occupant of the automobile or is moving towards the automobile with the intention of entering the vehicle. The attire may be one of various categories such as a business attire category, a business-casual attire category, a casual attire category, or a social attire category. The travel destination may be additionally predicted based on other factors such as an attire worn by a co-occupant of the automobile and historical data associated with the occupant and/or the co-occupant. The historical data may include a record of times at which the occupant traveled to a particular destination and the attire worn by the occupant when traveling to the destination.

### FIELD OF THE DISCLOSURE

This disclosure generally relates to automobile travel, and more particularly relates to automated features provided in an automobile for assisting an individual when using the automobile.

### BACKGROUND

Automobile manufacturers are constantly striving to offer in their automobiles various features that make their products more attractive to buyers. These features are typically directed at providing comfort, convenience, and satisfaction to drivers and passengers. For example, some automobiles have Bluetooth® enabled systems that allow a driver to use voice commands to perform various actions such as making a hands-free phone call, controlling a radio using voice commands, or configuring a navigation system. As another example, some automobiles have a computer system that monitors driving characteristics of a driver, such as a minor child for example, and controls a speed of the car in accordance with some rules programmed into the computer system. In yet another example, some automobiles include sensors that monitor a driver for signs of drunkenness or sleepiness. Upon detecting such a condition, a computer system that is coupled to the sensors may operate a buzzer to alert the driver, or may force the automobile to come to a halt.

It is desirable to provide such comfort, convenience, and satisfaction features not only in automobiles that are currently operated by human drivers but also in autonomous automobiles that have become the focus of various developmental efforts of late.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 shows a system that includes some exemplary components associated with predicting a travel destination of an automobile in accordance with an exemplary embodiment of the disclosure.

FIG. 2 shows an exemplary view of an interior of an automobile having a travel destination prediction system in accordance with the disclosure.

FIG. 3 shows a first exemplary flowchart of a method to predict a travel destination of an automobile in accordance with an exemplary embodiment of the disclosure.

FIG. 4 shows a second exemplary flowchart of a method to predict a travel destination of an automobile in accordance with an exemplary embodiment of the disclosure.

FIG. 5 shows a third exemplary flowchart of a method to predict a travel destination of an automobile in accordance with an exemplary embodiment of the disclosure.

### DETAILED DESCRIPTION

The disclosure will be described more fully hereinafter with reference to the accompanying drawings, in which exemplary embodiments of the disclosure are shown. This disclosure may, however, be embodied in many different forms and should not be construed as limited to the exemplary embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described exemplary embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and terms are used herein solely for convenience and such words and terms should be interpreted as referring to various objects and actions that are generally understood in various forms and equivalencies by persons of ordinary skill in the art. For example, the word “automobile” may be interchangeably used with the word “vehicle.” The phrase “autonomous vehicle” may be alternatively understood to refer to a “robotic vehicle,” a “self-driving vehicle,” and other such phrases. The phrase “ride services” as used herein refers to various types of transportation services such as taxi services, limousine services, shuttle services, carpool services, and rideshare services such as Uber™ and Lyft™. Furthermore, it should be understood that the word “example” as used herein is intended to be non-exclusionary and non-limiting in nature. More particularly, the word “exemplary” as used herein indicates one among several examples, and it should be understood that no undue emphasis or preference is being directed to the particular example being described.

In terms of a general overview, certain embodiments described in this disclosure are directed to systems and methods for predicting a travel destination of an automobile, based at least in part on identifying a category of an attire worn by an individual who is an occupant of the automobile or is moving towards the automobile with the intention of entering the vehicle. The attire may be one of various categories such as a business attire category, a business-casual attire category, a casual attire category, or a social attire category. The travel destination may be additionally predicted based on other factors such as an attire worn by a co-occupant of the automobile and historical data associated with the occupant and/or the co-occupant. The historical data may include a record of times at which the occupant previously traveled to a particular destination and the attire worn by the occupant when traveling to the destination.

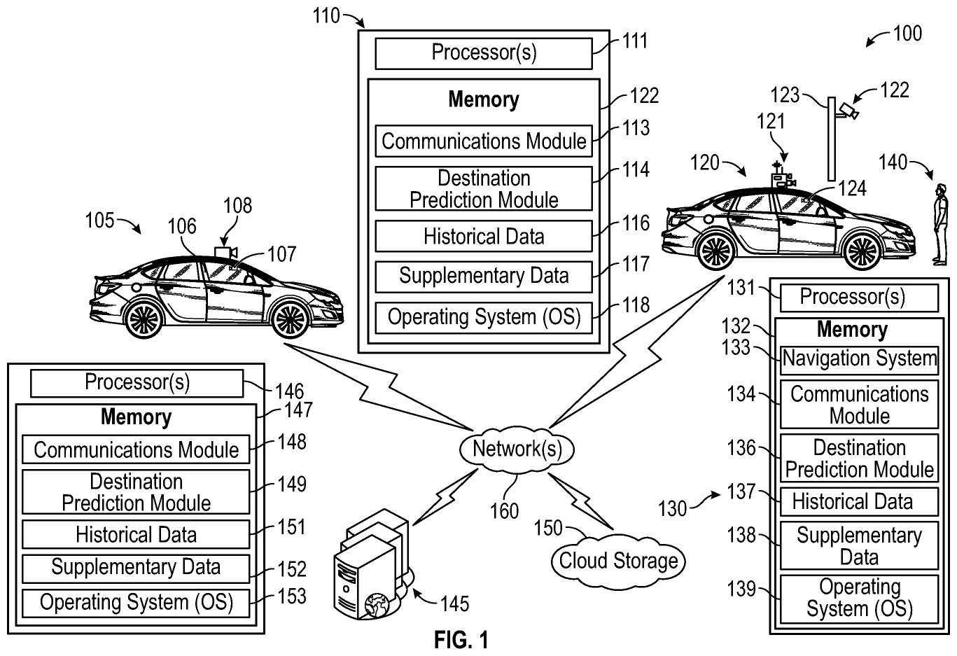

FIG. 1 shows a travel destination prediction system 100 that includes some exemplary components that may be associated with predicting a travel destination of an automobile in accordance with an exemplary embodiment of the disclosure. The exemplary components may be incorporated, wholly or in a distributed arrangement, in an autonomous vehicle 120, a driver-operated vehicle 105, a server computer system 145, and/or cloud storage 150. When the components are provided in a distributed arrangement, the autonomous vehicle 120, the driver-operated vehicle 105, the server computer system 145, and/or the cloud storage 150 may interact with each other by communicating over a network 160. The network 160 may include any one or a combination of various networks such as a local area network (LAN), a wide area network (WAN), a telephone network, a cellular network, a cable network, a wireless network, and/or private/public networks such as the Internet. In some instances, the network 160 may support communication technologies such as Bluetooth, cellular, near-field communication (NFC), Wi-Fi, Wi-Fi direct, machine-to-machine communication, and/or man-to-machine communication.

A first exemplary component that may be a part of the travel destination prediction system 100 is a computer system 130 that is installed in the autonomous vehicle 120. In one exemplary implementation, the autonomous vehicle 120 is a part of a rideshare service (such as Uber™ or Lyft™), a taxi service, a limousine service, or a shuttle service. In another exemplary implementation, the autonomous vehicle 120 may be owned and operated by an individual 140.

The computer system 130 may include several components such as a processor 131 and a memory 132. The memory 132, which is one example of a non-transitory computer-readable medium, may be used to store an operating system (OS) 139 and various other code modules such as a navigation system 133, a communications module 134, and a destination prediction module 136. The memory 132 may also be used to store data and information such as historical data 137 and supplementary data 138. The various code modules may be configured to carry out various operations in cooperation with various types of hardware provided in the autonomous vehicle 120. For example, the navigation system 133 may include one or more code modules that cooperate with various hardware components of the autonomous vehicle 120 for assisting the autonomous vehicle 120 in navigating around vehicles, pedestrians, and objects that may be encountered when the autonomous vehicle 120 is driving down a road. A few examples of such hardware components may include the navigation assistance equipment 121 of the autonomous vehicle 120, a steering mechanism of the autonomous vehicle 120, an ignition switch of the autonomous vehicle 120, an accelerator of the autonomous vehicle 120, a braking mechanism of the autonomous vehicle 120, a door lock mechanism of the autonomous vehicle 120, and a Global Positioning System (GPS) system.

The navigation assistance equipment 121, which may be mounted on the roof of the autonomous vehicle 120, can include various elements such as transponders, sensors, and imaging devices. A few exemplary sensors that may be a part of the navigation assistance equipment 121 are motion detectors, distance sensors, proximity sensors, and audio sensors. A few example imaging devices that may be a part of the navigation assistance equipment 121 include a digital camera configured to capture digital images or a video camera configured to capture video footage.

The communications module 134 may be used by the autonomous vehicle 120 in cooperation with a transponder in the navigation assistance equipment 121 to communicate with various entities such as the server computer system 145, the cloud storage 150, a ride service operator (not shown) of a ride service, and/or a computer system of the ride service operator. The communications may be carried out in machine-to-machine form when the computer system 130 of the autonomous vehicle 120 is communicating with the server computer system 145, the cloud storage 150, and/or the computer system of the ride service operator. Communications between the computer system 130 and the ride service operator may be carried out via machine-to-human communications (using a synthesized voice for example) and/or human-to-machine communications (voice-controlled applications).

The destination prediction module 136 may include one or more software modules that cooperate with hardware in the autonomous vehicle 120 such as the navigation assistance equipment 121 mounted on the roof of the autonomous vehicle 120 and/or an imaging system 124 mounted in an interior portion of the autonomous vehicle 120. In an exemplary embodiment, the destination prediction module 136 receives one or more images captured by an imaging device (camera, video camera, etc.) of the navigation assistance equipment 121 and/or by an imaging system 122. In one exemplary implementation, the imaging system 122 may be mounted on a fixture 123 near the autonomous vehicle 120. The fixture 123 may be, for example, a pillar in a garage where the autonomous vehicle 120 is parked, a pole in a parking lot, or a wall of a building. In another exemplary implementation, the imaging system 122 may be a part of a smart home system and may be located inside a residence of the individual 140. For example, the imaging system 122 may be installed on a doorway or wall inside the residence or may be built into a set-top box that is a part of the smart home system. The imaging system 122 may also be part of an internet-enabled device located outside the autonomous vehicle 120, and can include wireless communication equipment that sends the captured images to the navigation assistance equipment 121 mounted on the roof of the autonomous vehicle 120, from where the images may be transferred to the computer system 130 for processing to predict a travel destination.

In another exemplary embodiment, the computer system 130 receives and processes one or more images captured by the imaging system 124 that is mounted in an interior portion of the autonomous vehicle 120. The imaging system 124 can include one or more cameras such as a digital camera that captures digital images of an interior portion of the autonomous vehicle 120 and/or a video camera that captures video footage of an interior portion of the autonomous vehicle 120. The imaging system 124 may be mounted at various locations inside the autonomous vehicle 120 such as on an interior surface of a front windshield of the autonomous vehicle 120, on a rear-view mirror in the autonomous vehicle 120, or on a pillar of the car frame of the autonomous vehicle 120 in order to capture digital images of a seating area in the autonomous vehicle 120. In some implementations, a single digital camera or video camera may prove inadequate to capture digital images of an entire seating area in the autonomous vehicle 120. Consequently, multiple cameras may be mounted in various locations inside the autonomous vehicle 120 so as to capture digital images of the seating area from multiple angles.

The image (or images) captured by the imaging system 124 mounted in the interior portion of the autonomous vehicle 120, the imaging system 122 mounted on the fixture 123, and/or the imaging device that is a part of the navigation assistance equipment 121 includes at least a portion of an attire worn by the individual 140. The individual 140 may be a male or a female who is moving towards the autonomous vehicle 120 with the intention of entering the autonomous vehicle 120.

A single image captured by one of the various imaging systems or multiple images captured by two or more of the imaging systems may be processed by the destination prediction module 136 in the computer system 130 for identifying a category of the attire worn by the individual 140. The category of the attire worn by the individual 140 may be one among a set of categories each of which is categorized on the basis of various attributes. For example, the set of categories may include a first category categorized on the basis of one or more attributes of a business attire, a second category categorized on the basis of one or more attributes of a business-casual attire, a third category categorized on the basis of one or more attributes of a casual attire, and a fourth category categorized on the basis of one or more attributes of a social attire.

For example, various attributes of the business attire may include items such as a suit, a tie, and/or a jacket worn by the individual 140 when traveling to work in the autonomous vehicle 120 on certain days (for example, on days when a formal meeting is expected). Various attributes of the business-casual attire may include items such as a long-sleeved shirt, a long-sleeved blouse, or pants having a crease, that may be worn by the individual 140 when going in to work on some other days (for example, on days when the individual 140 may not be meeting with customers). Various attributes of the casual attire may include items such as a short-sleeved shirt or a tee-shirt that may be worn by the individual 140 when going in to work on certain days (on Fridays, for example), when going to meet a friend or acquaintance unrelated to work, or when going to a place other than a workplace (a gym or a store, for example). Various attributes of the social attire may include items such as clothes having colorful patterns that may be worn by the individual 140 when going to a party for example.

In some implementations, fewer or greater than four categories can be used, and one or more of these categories can be characterized using other criteria. In some other implementations, the various categories may be characterized using historical data 137. The historical data 137 may include data derived from images captured by the imaging system 122, the imaging system 124, and/or the imaging system in the navigation assistance equipment 121.

Some examples of historical data 137 may pertain to various attributes of an attire worn by the individual 140 during certain days or times. For example, the individual 140 may be a doctor, a policeman, a fireman, a nurse, or a security guard. Such a person may wear an attire that has a certain design, a certain color, and/or a certain logo, when traveling to work on weekdays. On the other hand, this person may wear a casual attire over the weekend. The historical data 137 may also include information such as a time (6 AM, for example) when the individual 140 enters the autonomous vehicle 120. Such a time would be suggestive that the individual 140 is setting off to work and would also be suggestive that the travel destination of the autonomous vehicle 120 at this time is a workplace of the individual 140. As another example, a time when the individual 140 enters the autonomous vehicle 120 (5 PM, for example) would be suggestive that the individual 140 is heading home from the workplace. Such time-related parameters may also be used by the computer system 130 to predict a travel destination.

The historical data 137 may also include location data obtained from a GPS device in the autonomous vehicle 120. For example, the location data may be used in various ways such as to corroborate a determination made by the computer system 130 that the travel destination at 5 PM is a residence of the individual 140. The corroboration may be carried out by confirming that the GPS coordinates obtained by the GPS device at that time correspond to an office building or a factory.

The destination prediction module 136 may use the historical data 137 and/or the supplementary data 138 stored in the memory 132, for predicting a travel destination of the autonomous vehicle 120. The supplementary data 138 may include, for example, attire information, category information, destination information, and/or correction of errors that may be committed by the destination prediction module 136. In one exemplary embodiment, the computer system 130 may operate in a learning mode that can include populating and/or updating the supplementary data 138 and/or the historical data 137, as well as automatically correcting errors made by the destination prediction module 136. The learning mode may be carried out by using various techniques such as by using learning algorithms, artificial intelligence, and machine learning. In another exemplary embodiment, a human operator may populate, edit, and/or update the supplementary data 138 and/or the historical data 137.

The driver-operated vehicle 105 may include various components of the travel destination prediction system 100, such as an imaging system 107 and an imaging system 108. The computer system 110 located in the driver-operated vehicle 105 may include at least some components such as a processor 111 and a memory 112 that are functionally similar to the components in the computer system 130 of the autonomous vehicle 120. The memory 112, which is another example of a non-transitory computer-readable medium, may be used to store an operating system (OS) 118 and various other code modules such as a communications module 113 and a destination prediction module 114. The memory 112 may also store historical data 116 and supplementary data 117. The communications module 113 and the destination prediction module 114 in the memory 112 may be similar to, or modified versions of, the communications module 134 and the destination prediction module 136 in the memory 132 of the autonomous vehicle 120. The historical data 116 in the memory 112 may also be similar to the historical data 137 in the memory 132 of the autonomous vehicle 120. However, the navigation system 133 that is included in the computer system 130 of the autonomous vehicle 120 may be omitted in the computer system 110 installed in the driver-operated vehicle 105 because the driver 106 performs the navigating functions in the driver-operated vehicle 105.

The code modules may be configured to cooperate with various types of hardware provided in the driver-operated vehicle 105 for carrying out various operations. In a first exemplary implementation, the destination prediction module 114 may execute the various travel destination prediction operations described herein by cooperating with one or more of the imaging system 107, the imaging system 108, an imaging system mounted on a fixture (similar to the imaging system 122), and/or an internet-enabled device located outside the driver-operated vehicle 105 (inside a residence or an office, for example). The operations of the destination prediction module 114 may be carried out without intervention from the driver 106. In an alternative implementation, the driver 106 may perform some functions such as manually operating the imaging system 107 for initiating image capture by the imaging system 107 and/or for submitting input into the supplementary data 117 stored in the memory 112.

The supplementary data 117 may include, for example, attire information, category information, destination information, and/or correction of errors committed by the destination prediction module 114. In one exemplary embodiment, the computer system 110 may be configured to operate in a learning mode that can include populating and/or updating the supplementary data 117 and/or the historical data 116, as well as automatically correcting errors made by the destination prediction module 114. The learning mode may be carried out by using various techniques such as artificial intelligence and machine learning. In another exemplary embodiment, a human operator may populate, edit, and/or update the supplementary data 117 and/or the historical data 116.

The server computer system 145 may include one or more computers having some components of the travel destination prediction system 100 such as a processor 146 and a memory 147. The memory 147, which is another example of a non-transitory computer-readable medium, may be used to store an operating system (OS) 153 and various other code modules such as a communications module 148 and a destination prediction module 149. The memory 147 may also store historical data 151 and supplementary data 152. The communications module 148 and the destination prediction module 149 in the memory 147 may be similar to, or modified versions of, the communications module 134 and the destination prediction module 136 in the memory 132 of the autonomous vehicle 120. The historical data 151 and the supplementary data 152 in the memory 147 may also be similar to, or modified versions of, the historical data 116 and the supplementary data 117 in the memory 112 of the driver-operated vehicle 105. The navigation system 133 that is included in the computer system 130 of the autonomous vehicle 120 may be omitted in the server computer system 145.

In some exemplary implementations, the communications module 148 of the server computer system 145 may communicate with the communications module 113 of the driver-operated vehicle 105 and/or the communications module 134 of the autonomous vehicle 120 to allow the server computer system 145 to execute some or all of the travel destination prediction operations. Such operations carried out by the server computer system 145 may be done in support of operations carried out by the driver-operated vehicle 105 or the autonomous vehicle 120 respectively, or on behalf of the driver-operated vehicle 105 or the autonomous vehicle 120 respectively.

The cloud storage 150 may include one or more memory devices that store various types of data associated with the travel destination prediction system 100 such as, for example, copies of the historical data 116, the historical data 151, the historical data 137, the supplementary data 117, the supplementary data 152, and/or the supplementary data 138. The computer system 110 of the driver-operated vehicle 105 and/or the computer system 130 of the autonomous vehicle 120 may access the cloud storage 150 to obtain stored data. In some implementations, the contents of memory devices such as the memory 112 of the driver-operated vehicle 105 and/or the memory 132 of the autonomous vehicle 120 may be stored entirely, or partially, in the cloud storage 150. In some other implementations, data stored in the cloud storage 150 may be duplicated or omitted in the memory 112 of the driver-operated vehicle 105 and/or in the memory 132 of the autonomous vehicle 120.

A memory device such as the memory 112, the memory 132, and the memory 147 shown in FIG. 1 can include any one memory element or a combination of volatile memory elements (e.g., random access memory (RAM, such as DRAM, SRAM, SDRAM, etc.)) and non-volatile memory elements (e.g., ROM, hard drive, tape, CD ROM, etc.). Moreover, the memory device may incorporate electronic, magnetic, optical, and/or other types of storage media. In the context of this document, a “non-transitory computer-readable medium” can be, for example, but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

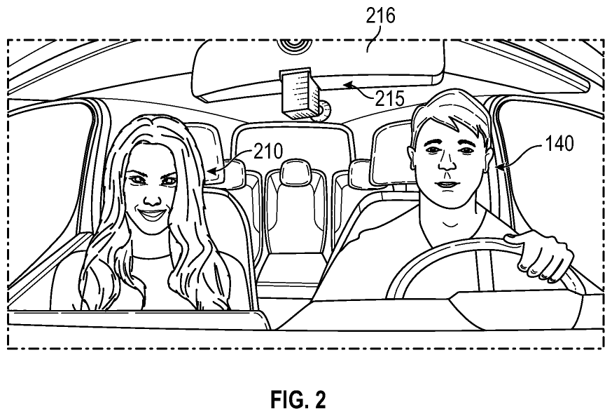

FIG. 2 shows an exemplary view of the interior of an automobile such as the autonomous vehicle 120 (or the driver-operated vehicle 105) having the travel destination prediction system 100 in accordance with the disclosure. In this exemplary embodiment, an imaging device 215 is mounted upon a rear-view mirror 216 of the autonomous vehicle 120 or may be similarly mounted in the driver-operated vehicle 105. The imaging device 215 may be used to capture one or more images of the individual 140 when seated inside the autonomous vehicle 120 (or the driver-operated vehicle 105). The one or more image may include at least a top portion of an attire worn by an individual 140 (a shirt, for example). This portion of the attire may be processed by the computer system 130 for identifying a category of the attire and for predicting a travel destination based on the identification.

In some embodiments, corroboration of a travel destination prediction made by the computer system 130 may be carried out by capturing an image of a second individual 210 seated inside the autonomous vehicle 120. The first individual (individual 140) may be a driver of the driver-operated vehicle 105, and the second individual 210 may be a passenger in the driver-operated vehicle 105. The information derived by identifying an attire worn by the second individual 210 may corroborate the travel destination, when, for example, both the individual 140 and the second individual 210 are wearing attires belonging to the same category. Some examples of such an occurrence may occur when the autonomous vehicle 120 is being used as a carpool service for both occupants to go to work (both are co-workers wearing business attire, for example) or for both individuals going to a party (husband and wife wearing casual attire, for example).

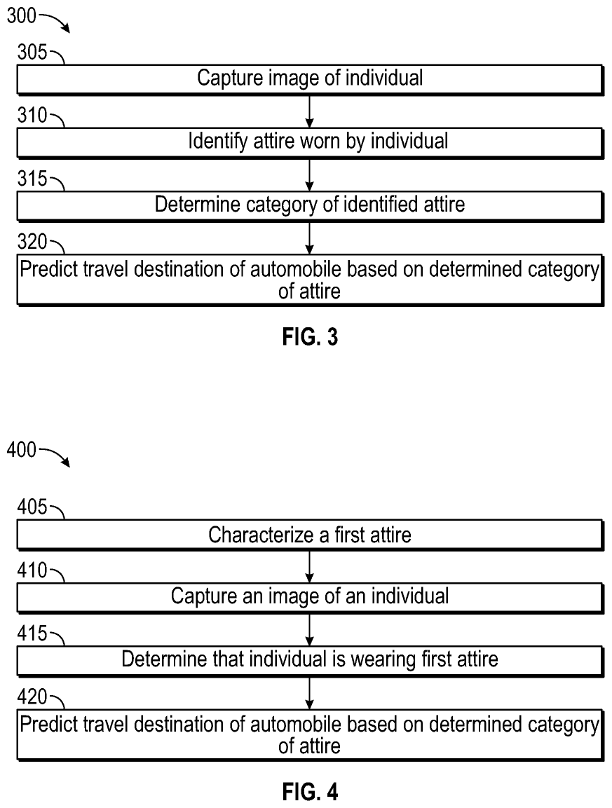

FIG. 3 shows a first exemplary flowchart 300 of a method to predict a travel destination of an automobile such as the driver-operated vehicle 105 or the autonomous vehicle 120, in accordance with an exemplary embodiment of the disclosure. The flowchart 300 (and the flowchart 400 that is described below) illustrates a sequence of operations that can be implemented in hardware, software, or a combination thereof. In the context of software, the operations represent computer-executable instructions stored on one or more non-transitory computer-readable media such as the memory 112, the memory 147, and the memory 132, that, when executed by one or more processors such as the processor 111, the processor 146, and the processor 131 respectively, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel. Some or all of the operations described in the flowchart 300 may be carried out by using an application such as the destination prediction module 136 in the memory 132 of the computer system 130 in the autonomous vehicle 120, the destination prediction module 114 in the memory 112 of the computer system 110 in the driver-operated vehicle 105, or the destination prediction module 149 in the memory 147 of the server computer system 145.

At block 305, an imaging system is used to capture at least one image of an individual. For example, the navigation assistance equipment 121 may be used to capture an image of the individual 140 walking towards the autonomous vehicle 120 and/or the imaging system 124 may be used to capture an image of the individual 140 when seated in the autonomous vehicle 120. In the case of the driver-operated vehicle 105, the imaging system 108 may be used to capture an image of the individual 140 walking towards the driver-operated vehicle 105 and/or the imaging system 107 may be used to capture an image of the individual 140 when seated in the driver-operated vehicle 105.

At block 310, the image or images of the individual are processed by a computer system to identify an attire worn by the individual. For example, the image of the individual 140 may be processed by the processor 131 of the computer system 130 in the autonomous vehicle 120 to identify an attire worn by the individual 140.

At block 315, the computer system determines that the attire belongs to a certain category among a set of categories. For example, the destination prediction module 136 of the computer system 130 in the autonomous vehicle 120 may determine that the individual 140 is wearing a business attire. The determination may be carried out by processing the image(s) provided by the navigation assistance equipment 121 (and/or the imaging system 124) and/or by using one or both of the historical data 137 and the supplementary data 138. In the case of the driver-operated vehicle 105, the determination may be carried out by processing the image(s) provided by the imaging system 108 (and/or the imaging system 107) and/or by using one or both of the historical data 116 and the supplementary data 117.

At block 320, the computer system predicts a travel destination of an automobile (such as the autonomous vehicle 120 or the driver-operated vehicle 105), based on determining the category of the attire worn by the individual 140, for example. The travel destination may also be predicted based on other factors such as an attire worn by a co-occupant of the automobile, a time of travel, past history (historical data), and/or supplementary data.

FIG. 4 shows a second exemplary flowchart 400 of a method to predict a travel destination of an automobile such as the driver-operated vehicle 105 or the autonomous vehicle 120, in accordance with an exemplary embodiment of the disclosure. At block 405, a first attire is characterized based on one or more attributes of the first attire. For example, the first attire may be characterized as a business attire based on items such as a suit, a tie, and/or a jacket. The characterization of the attire may be carried out in various ways such as by processing multiple images of an individual, by using historical data, and/or by using supplementary data. As another example, the first attire may be characterized as a casual attire based on one or more clothing items such as a short-sleeved shirt or a tee-shirt. As yet another example, the first attire may be characterized as a social attire based on one or more clothing items having colorful patterns.

At block 410, an imaging system is used to capture at least one image of an individual. For example, the navigation assistance equipment 121 may be used to capture an image of the individual 140 walking towards the autonomous vehicle 120 and/or the imaging system 124 may be used to capture an image of the individual 140 when seated in the autonomous vehicle 120. In the case of the driver-operated vehicle 105, the imaging system 108 may be used to capture an image of the individual 140 walking towards the driver-operated vehicle 105 and/or the imaging system 107 may be used to capture an image of the individual 140 when seated in the driver-operated vehicle 105.

At block 415, the image or images of the individual are processed by a computer system to determine that the individual is wearing the first attire. For example, the image of the individual 140 may be processed by the processor 131 of the computer system 130 in the autonomous vehicle 120 to determine that the first attire is a business attire.

At block 420, the computer system predicts a travel destination of an automobile, such as the autonomous vehicle 120 or the driver-operated vehicle 105, based on determining that the individual 140 is wearing the business attire, for example. The travel destination may also be predicted based on other factors such as an attire worn by a co-occupant of the automobile, a time of travel, past history (historical data), and/or supplementary data.

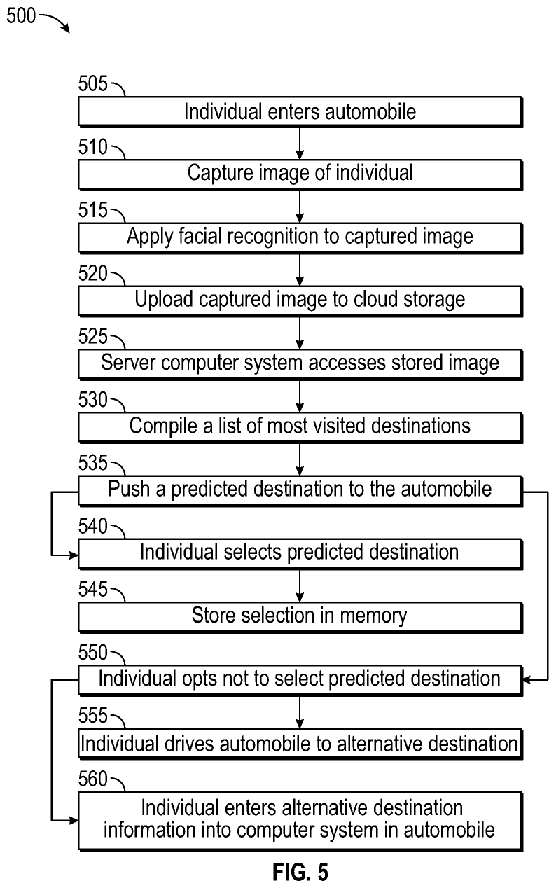

FIG. 5 shows a third exemplary flowchart 500 of a method to predict a travel destination of an automobile, such as the driver-operated vehicle 105 or the autonomous vehicle 120, in accordance with an exemplary embodiment of the disclosure. At block 505, the individual 140 enters a vehicle such as the driver-operated vehicle 105 or the autonomous vehicle 120. At block 510, an imaging system such as the imaging system 107 or the imaging system 124 captures an image(s) of the individual 140. At block 515, facial recognition may be used to associate the captured image(s) with the individual 140 and/or with parameters such as travel destinations and clothing preferences of the individual 140. The facial recognition operation may be omitted in some embodiments.

At block 520, the computer system in the automobile, such as the computer system 110 in the driver-operated vehicle 105 or the computer system 130 in the autonomous vehicle 120, may upload the image(s) to the cloud storage 150. The uploading may be carried out, for example, by using the communications module 134 and the navigation assistance equipment 121 of the autonomous vehicle 120 or by using the communications module 113 and a transponder (not shown) located in the driver-operated vehicle 105.

At block 525, the server computer system 145 may access the image(s) stored in the cloud storage 150 and process the image(s) for purposes of characterizing the attire worn by the individual 140, and/or to process the image(s) to determine the category of attire worn by the individual 140. At block 530, the server computer system 145 may compile a list of destinations that were visited by the individual 140 while wearing this category of attire. At block 535, the compiled list of destinations and/or a destination predicted by the travel destination prediction system 100 based on the attire worn by the individual 140 may be pushed to the computer system in the automobile.

At block 540, the individual 140 may select a destination from among the list of destinations and/or the predicted destination. At block 545, the selection may be stored in the memory of the automobile (memory 112 or memory 132) so as to associate the selection with the automobile and/or the individual 140. At block 550, the individual 140 opts not to select a destination from among the list of destinations and/or the predicted destination. At block 555, the individual 140 drives the automobile to an alternative destination that is different than the predicted destination. The GPS coordinates of the alternative destination may be stored in the memory (for example in the form of supplementary data). A filtering procedure may be employed to eliminate storing of information pertaining to intermediate stops such as at gas stations and traffic lights. The filtering procedure may also be applied in some situations to eliminate storing of information pertaining to the alternative destination and/or the attire worn by the individual 140 when traveling to the alternative destination. For example, the filtering procedure may be applied if the alternative destination has been erroneously selected by the individual 140 and corrected either before reaching the alternative destination or after reaching the alternative destination. Such an occurrence, which may be viewed as an outlier or a false-positive occurrence, may also be eliminated by using the learning mode and/or by using statistical computation procedures. In some implementations, information pertaining to outliers may be stored as supplementary data 138 and used to improve prediction accuracy from then on. At block 560, the individual 140 may use a keyboard coupled to the computer system 130, for example, to enter data pertaining to the alternative destination. Data associated with the alternative destination may be stored in the memory (for example in the form of supplementary data) and/or uploaded to cloud storage 150.

### EXAMPLE EMBODIMENTS

In some instances, the following examples may be implemented together or separately by the systems and methods described herein.

Example 1 may include a method comprising: capturing, by an imaging system, at least one image of a first individual; processing, by at least a first computer system, the at least one image of the first individual to identify a first attire worn by the first individual; determining, by at least the first computer system, that the first attire belongs to a first category among a set of categories; and predicting, by at least the first computer system and based at least in part on determining that the first attire belongs to the first category, a travel destination of an automobile operable to transport the first individual to the travel destination.

Example 2 may include the method of example 1, wherein: the first individual is a driver of the automobile, the imaging system is located in the automobile, and the first category is categorized on the basis of one or more attributes of one of a business attire, a business-casual attire, a casual attire, or a social attire.

Example 3 may include the method of example 1 and/or some other example herein, wherein the first individual is a driver of the automobile, wherein the first category is categorized on the basis of one or more attributes of a business attire, and wherein the set of categories further comprises a second category categorized on the basis of one or more attributes of a business-casual attire, a third category categorized on the basis of one or more attributes of a casual attire, and a fourth category categorized on the basis of one or more attributes of a social attire.

Example 4 may include the method of example 1 and/or some other example herein, wherein predicting, by at least the first computer system, the travel destination of the automobile based at least in further part on a history of previous travel destinations of the automobile.

Example 5 may include the method of example 4 and/or some other example herein, wherein the history of previous travel destinations of the automobile is stored in at least one of a global positioning system (GPS) device, one or more memory devices in the first computer system, one or more memory devices in a second computer system, or one or more memory devices in cloud storage.

Example 6 may include the method of example 1 and/or some other example herein, further comprising: capturing, by the imaging system, at least one image of a second individual; processing, by at least the first computer system, the at least one image of the second individual to identify a second attire worn by the second individual; determining, by at least the first computer system, that the second attire belongs to the first category among the set of categories; and predicting, by at least the first computer system, the travel destination of the automobile based at least in part on determining that each of the first attire and the second attire belongs to the first category.

Example 7 may include the method of example 6 and/or some other example herein, wherein each of the imaging system and the first computer system is located in the automobile, and wherein the second individual is a passenger in the automobile.

Example 8 may include a method comprising: characterizing a first attire based at least in part on one or more attributes of the first attire; capturing, by an imaging system, at least one image of a first individual; processing, by at least a first computer system, the at least one image to determine that the first individual is wearing the first attire; and predicting, by at least the first computer system and based at least in part on determining that the first individual is wearing the first attire, a travel destination of an automobile operable to transport the first individual to the travel destination.

Example 9 may include the method of example 8, wherein: the first individual is a driver of the automobile, the imaging system is located in the automobile, and the one or more attributes of the first attire indicate one of a business attire, a business-casual attire, a casual attire, or a social attire.

Example 10 may include the method of example 9 and/or some other example herein, wherein: the one or more attributes of the business attire comprise at least one of a suit, a tie, or a jacket, the one or more attributes of the business-casual attire comprise at least one of a long-sleeved shirt, a long-sleeved blouse, or pants having a crease, the one or more attributes of the casual attire comprise at least one of a short-sleeved shirt or a tee-shirt, and the one or more attributes of the social attire comprises at least one item of clothing that has colorful patterns.

Example 11 may include the method of example 9 and/or some other example herein, wherein predicting, by at least the first computer system, the travel destination of the automobile based at least in further part on at least one of a history of previous travel destinations of the automobile, two or more previous time-related parameters of travel by the first individual in the automobile, or a learning algorithm executed in at least the first computer system.

Example 12 may include the method of example 11 and/or some other example herein, wherein the history of previous travel destinations of the automobile is stored in at least one of a global positioning system (GPS) device, one or more memory devices in the first computer system, one or more memory devices in a second computer system, or one or more memory devices in cloud storage.

Example 13 may include the method of example 8 and/or some other example herein, further comprising: capturing, by the imaging system, at least one image of a second individual who is an occupant of the automobile; processing, by at least the first computer system, the at least one image to determine that the second individual is wearing the first attire; and predicting, by at least the first computer system, the travel destination of the automobile further based at least in part on determining that the second individual is wearing the first attire.

Example 14 may include the method of example 13 and/or some other example herein, wherein the automobile is an autonomous vehicle.

Example 15 may include a system comprising: an imaging system configured to capture at least one image of a first individual; and a first computer system comprising: at least one memory that stores computer-executable instructions; and at least one processor configured to access the at least one memory and execute the computer-executable instructions to at least: process the at least one image of the first individual to identify a first attire worn by the first individual; determine that the first attire belongs to a first category among a set of categories; and predict a travel destination of an automobile based at least in part on determining that the first attire belongs to the first category, wherein the automobile is configured to provide transportation to the first individual.

Example 16 may include the system of example 15, wherein the first individual is a driver of the automobile, and wherein the first category is categorized on the basis of one or more attributes of one of a business attire, a business-casual attire, a casual attire, or a social attire.

Example 17 may include the system of example 16 and/or some other example herein, wherein the imaging system is one of mounted in the automobile or mounted on a fixture outside the automobile.

Example 18 may include the system of example 15 and/or some other example herein, wherein the at least one processor executes the computer-executable instructions to predict the travel destination of the automobile based at least in further part on a history of previous travel destinations of the automobile, the history of the previous travel destinations of the automobile stored in at least one of a global positioning system (GPS) device, one or more memory devices in the first computer system, one or more memory devices in a second computer system, or one or more memory devices in cloud storage.

Example 19 may include the system of example 15 and/or some other example herein, wherein the automobile is an autonomous vehicle.

Example 20 may include the system of example 15 and/or some other example herein, wherein the at least one processor executes the computer-executable instructions to predict the travel destination of the automobile based at least in further part on data obtained from an internet-enabled device located outside the automobile.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
capturing, by an imaging system, at least one image of a first individual;
processing, by at least a first computer system, the at least one image of the first individual to identify a first attire worn by the first individual;
determining, by at least the first computer system, that the first attire belongs to a first category among a set of categories; and
predicting, by at least the first computer system and based at least in part on determining that the first attire belongs to the first category, a travel destination of an automobile operable to transport the first individual to the travel destination.

2. The method of claim 1, wherein:
the first individual is a driver of the automobile,
the imaging system is located in the automobile, and
the first category is categorized on the basis of one or more attributes of one of a business attire, a business-casual attire, a casual attire, or a social attire.

3. The method of claim 1, wherein the first individual is a driver of the automobile, wherein the first category is categorized on the basis of one or more attributes of a business attire, and wherein the set of categories further comprises a second category categorized on the basis of one or more attributes of a business-casual attire, a third category categorized on the basis of one or more attributes of a casual attire, and a fourth category categorized on the basis of one or more attributes of a social attire.

4. The method of claim 1, wherein predicting, by at least the first computer system, the travel destination of the automobile based at least in further part on a history of previous travel destinations of the automobile.

5. The method of claim 4, wherein the history of previous travel destinations of the automobile is stored in at least one of a global positioning system (GPS) device, one or more memory devices in the first computer system, one or more memory devices in a second computer system, or one or more memory devices in cloud storage.

6. The method of claim 1, further comprising:
capturing, by the imaging system, at least one image of a second individual;
processing, by at least the first computer system, the at least one image of the second individual to identify a second attire worn by the second individual;
determining, by at least the first computer system, that the second attire belongs to the first category among the set of categories; and
predicting, by at least the first computer system, the travel destination of the automobile based at least in part on determining that each of the first attire and the second attire belongs to the first category.

7. The method of claim 6, wherein each of the imaging system and the first computer system is located in the automobile, and wherein the second individual is a passenger in the automobile.

8. A method comprising:
characterizing a first attire based at least in part on one or more attributes of the first attire;
capturing, by an imaging system, at least one image of a first individual;
processing, by at least a first computer system, the at least one image to determine that the first individual is wearing the first attire; and
predicting, by at least the first computer system and based at least in part on determining that the first individual is wearing the first attire, a travel destination of an automobile operable to transport the first individual to the travel destination.

9. The method of claim 8, wherein:
the first individual is a driver of the automobile,
the imaging system is located in the automobile, and
the one or more attributes of the first attire indicate one of a business attire, a business-casual attire, a casual attire, or a social attire.

10. The method of claim 9, wherein:
the one or more attributes of the business attire comprise at least one of a suit, a tie, or a jacket,
the one or more attributes of the business-casual attire comprise at least one of a long-sleeved shirt, a long-sleeved blouse, or pants having a crease,
the one or more attributes of the casual attire comprise at least one of a short-sleeved shirt or a tee-shirt, and
the one or more attributes of the social attire comprises at least one item of clothing that has colorful patterns.

11. The method of claim 9, wherein predicting, by at least the first computer system, the travel destination of the automobile based at least in further part on at least one of a history of previous travel destinations of the automobile, two or more previous time-related parameters of travel by the first individual in the automobile, or a learning algorithm executed in at least the first computer system.

12. The method of claim 11, wherein the history of previous travel destinations of the automobile is stored in at least one of a global positioning system (GPS) device, one or more memory devices in the first computer system, one or more memory devices in a second computer system, or one or more memory devices in cloud storage.

13. The method of claim 8, further comprising:
capturing, by the imaging system, at least one image of a second individual who is an occupant of the automobile;
processing, by at least the first computer system, the at least one image to determine that the second individual is wearing the first attire; and
predicting, by at least the first computer system, the travel destination of the automobile further based at least in part on determining that the second individual is wearing the first attire.

14. The method of claim 13, wherein the automobile is an autonomous vehicle.

15. A system comprising:
an imaging system configured to capture at least one image of a first individual; and
a first computer system comprising:
at least one memory that stores computer-executable instructions; and
at least one processor configured to access the at least one memory and execute the computer-executable instructions to at least:
process the at least one image of the first individual to identify a first attire worn by the first individual;
determine that the first attire belongs to a first category among a set of categories; and
predict a travel destination of an automobile based at least in part on determining that the first attire belongs to the first category, wherein the automobile is configured to provide transportation to the first individual.

16. The system of claim 15, wherein the first individual is a driver of the automobile, and wherein the first category is categorized on the basis of one or more attributes of one of a business attire, a business-casual attire, a casual attire, or a social attire.

17. The system of claim 16, wherein the imaging system is one of mounted in the automobile or mounted on a fixture outside the automobile.

18. The system of claim 15, wherein the at least one processor executes the computer-executable instructions to predict the travel destination of the automobile based at least in further part on a history of previous travel destinations of the automobile, the history of the previous travel destinations of the automobile stored in at least one of a global positioning system (GPS) device, one or more memory devices in the first computer system, one or more memory devices in a second computer system, or one or more memory devices in cloud storage.

19. The system of claim 15, wherein the automobile is an autonomous vehicle.

20. The system of claim 15, wherein the at least one processor executes the computer-executable instructions to predict the travel destination of the automobile based at least in further part on data obtained from an internet-enabled device located outside the automobile.
